(19) United States
(12) Patent Application Publication
(10) Pub. No.: US 2025/0284869 A1
(43) Pub. Date: Sep. 11, 2025

(54) METHOD FOR MATCHING GUIDE VANE AND OUTLET PASSAGE OF LOW-LIFT PUMP STATION

(71) Applicant: Jiangsu University, Zhenjiang (CN)

(72) Inventors: Yanjun Li, Zhenjiang (CN); Jia Li, Zhenjiang (CN); Wenjie Wang, Zhenjiang (CN); Ji Pei, Zhenjiang (CN); Lianchen Liu, Zhenjiang (CN); Fan Meng, Zhenjiang (CN); Yalin Li, Zhenjiang (CN)

(21) Appl. No.: 19/070,470

(22) Filed: Mar. 4, 2025

(30) Foreign Application Priority Data
Mar. 6, 2024 (CN) 202410253505.2

(51) Int. Cl. G06F 30/28; F04D 29/24; G06F 30/17; G06F 111/06; G06F 113/08

(52) U.S. Cl. CPC G06F 30/28; F04D 29/24; G06F 30/17; G06F 2111/06; G06F 2113/08

(57) ABSTRACT

Disclosed in the disclosure is a method for matching a guide vane and an outlet passage of a low-lift pump station, including: collecting original data of a target pump station, and selecting, according to the original data, a combination pattern for combined adjustment of an axial length of a guide vane blade, a placement angle of a guide vane outlet and a diameter of the guide vane outlet by classification; and optimizing the combination pattern for combined adjustment of the axial length of the guide vane blade, the placement angle of the guide vane outlet and the diameter of the guide vane outlet, to obtain an optimal parameter combination scheme. According to the disclosure, the hydraulic performance of the guide vane is improved, the hydraulic loss of the outlet passage is reduced, and the efficiency of a pump device is enhanced.

### CROSS-REFERENCE TO RELATED APPLICATION

This application claims priority of Chinese Patent Application No. 202410253505.2, filed on Mar. 6, 2024, the entire contents of which are incorporated herein by reference.

### TECHNICAL FIELD

The disclosure belongs to the technical field of hydraulic machinery optimization design, and in particular to a method for matching a guide vane and an outlet passage of a low-lift pump station.

### BACKGROUND

Currently, low-lift pump stations are extensively applied in various fields such as water resource allocation, scheduling and irrigation, as well as water supply for residents' living. During the operation of pump stations, guide vanes can guide water flow from vane wheels, reducing a circumferential velocity of the water flow to a value near zero at the outlet from a relatively large value at the inlet, so as to achieve the function of energy recovery. At present, the research on guide vanes primarily focuses on energy recovery and their matching with vane wheels, and few research on the matching between guide vanes and outlet passages. Guide vanes from high-efficiency pump sections and outlet passages with excellent performance are combined by splicing, which, however, does not maximize the efficiency of a pump device due to the presence of hydraulic coherence effect between the guide vanes and the outlet passages. To further improve the efficiency of the pump device and broaden a high-efficiency operation range of the pump device, the matching between the guide vanes and the outlet passages is required.

### SUMMARY

To solve the technical problem described above, the disclosure provides a method for matching a guide vane and an outlet passage of a low-lift pump station, improving the hydraulic performance of the guide vane, reducing the hydraulic loss of the outlet passage, and improving the efficiency of a pump device.

To realize the above objective, the disclosure provides a method for matching a guide vane and an outlet passage of a low-lift pump station, including: collecting original data of a target pump station, and selecting, according to the original data, a combination pattern for combined adjustment of an axial length of a guide vane blade, a placement angle of a guide vane outlet and a diameter of the guide vane outlet by classification; and
optimizing a selected combination pattern for combined adjustment of the axial length of the guide vane blade, the placement angle of the guide vane outlet and the diameter of the guide vane outlet, to obtain an optimal parameter combination scheme.

In an alternative embodiment, the original data of the target pump station include: a design flow, a design lift, a three-dimensional structure of a running wheel, guide vane parameters and a three-dimensional structure of a passage of the target pump station.

In an alternative embodiment, selecting the combination pattern for combined adjustment of the axial length of the guide vane blade, the placement angle of the guide vane outlet and the diameter of the guide vane outlet includes:
the combination pattern for the axial length of the guide vane blade, the placement angle of the guide vane outlet and the diameter of the guide vane outlet including: a single combination pattern, a two-factor combination pattern or a three-factor combination pattern.

In an alternative embodiment, a classification method for selecting the combination pattern for combined adjustment of the axial length of the guide vane blade, the placement angle of the guide vane outlet, and the diameter of the guide vane outlet includes:
constructing a classification model using a classification algorithm according to data stored in a database, and determining the combination pattern and a threshold range for the axial length of the guide vane blade, the placement angle of the guide vane outlet and the diameter of the guide vane outlet according to a pump type, a passage form and the similarity between a distribution pattern of residual velocity circulation at the guide vane outlet and the data stored in the database.

In an alternative embodiment, a method for optimizing the combination pattern for combined adjustment of the axial length of the guide vane blade, the placement angle of the guide vane outlet and the diameter of the guide vane outlet, to obtain the optimal parameter combination scheme includes:
sampling the axial length of the guide vane blade, the placement angle of the guide vane outlet and the diameter of the guide vane outlet, establishing a solid model of a computational domain of a pump device and performing simulation calculations to obtain calculation results; fitting a nonlinear correlation of threshold parameters in the calculation results, and optimizing a fitted nonlinear correlation using an intelligent optimization algorithm to obtain the optimal parameter combination scheme for the axial length of the guide vane blade, the placement angle of the guide vane outlet and the diameter of the guide vane outlet.

In an alternative embodiment, the data stored in the database include:
pump station data including the design flow, the design lift, the three-dimensional structure of the running wheel, the guide vane parameters and the three-dimensional structure of the passage;
pump station operation calculation data include a pump efficiency, a hydraulic loss and a residual circulation distribution at the guide vane outlet; and
matching scheme data of the guide vane and the outlet passage of the pump station.

In an alternative embodiment, a method for sampling the axial length of the guide vane blade, the placement angle of the guide vane outlet and the diameter of the guide vane outlet includes: performing, on the basis of the data stored in the database, adjustment within a limited optimization parameter threshold range according to the threshold range and the combination pattern for the axial length of the guide vane blade, the placement angle of the guide vane outlet and the diameter of the guide vane outlet, and sampling optimization variables.

In an alternative embodiment, a method for fitting the nonlinear correlation of the threshold parameters in the calculation results includes: generating the solid model of the computational domain of the pump device according to obtained sampling points, performing the simulation calculations, transmitting the calculation results into the database, establishing an approximate model on the basis of the calculation results, and fitting the nonlinear correlation between the calculation results and the optimization variables.

In an alternative embodiment, a method for optimizing the fitted nonlinear correlation using the intelligent optimization algorithm to obtain the optimal combination pattern for the axial length of the guide vane blade, the placement angle of the guide vane outlet and the diameter of the guide vane outlet includes: optimizing the fitted nonlinear correlation using the intelligent optimization algorithm to obtain an optimal scheme under the combination pattern, and determining a final scheme by comparing; and determining the optimal scheme obtained by an optimization subsystem to be the final scheme if only one combination pattern is obtained by a classification program.

In an alternative embodiment, the final scheme includes the diameter of the guide vane outlet D_{gvo} being equal to a diameter of an outlet passage inlet, an adjustment to the diameter of the guide vane outlet D_{gvo}, and synchronous updates to the diameter of the outlet passage inlet.

Technical effect of the disclosure: a method for matching a guide vane and an outlet passage of a low-lift pump station is disclosed in the disclosure, and the matching method between guide vanes and outlet passages is integrated. For various pump types and various outlet passage forms in the low-lift pump station, a suitable guide vane parameter combination pattern can be determined by means of the database and the classification program according to their type or similarity in the axial velocity distribution pattern at the guide vane outlet, thereby reducing the computational load in the matching process and enhancing accuracy. Optimization parameters are selected according to the determined guide vane parameter combination pattern, and the optimization parameter threshold is determined on the basis of the database. Fast optimization is performed with the aid of intelligent optimization algorithms, eliminating the influence of manual experience in the matching design process, and quickly and accurately obtaining the design scheme for the guide vane and the outlet passage. This not only shortens the training period for designers, but also maximizes the improvement of water flow patterns in guide vanes and outlet passages, thereby reducing the overall hydraulic losses of the pump device, enhancing the overall efficiency of energy recovery in guide vanes and outlet passages, and consequently boosting the efficiency of the pump device while broadening a high-efficiency operation range of the pump device.

### BRIEF DESCRIPTION OF THE DRAWINGS

The accompanying drawings as a part of this application serve for providing further understanding of this application. The schematic embodiment of this application and descriptions thereof are used for interpreting this application rather than constituting undue qualification of this application. In the accompanying drawings:

FIG. 1 shows a flowchart of a method for matching a guide vane and an outlet passage of a low-lift pump station according to an embodiment of the disclosure;

FIG. 2 is a schematic structural diagram of a pump device according to an embodiment of the disclosure;

FIG. 3 is a schematic diagram showing the adjustment of an axial length of a guide vane blade L_{gv} according to an embodiment of the disclosure;

FIG. 4 is a schematic diagram showing the adjustment of a placement angle of a guide vane outlet β according to an embodiment of the disclosure; and

FIG. 5 is a schematic diagram showing the adjustment of a diameter of the guide vane outlet D_{gvo} according to an embodiment of the disclosure.

Reference numerals and denotations thereof: 1-inlet passage; 2-vane wheel; 3-vane wheel blade; 4-guide vane; 5-guide vane blade; 6-outlet passage; (a), (b), (c), and (d)-design schemes for axial length of guide vane blade L_{gv}; (e) and (f)-design schemes for placement angle of guide vane outlet β; and (g), (h), and (i)-design schemes for diameter of guide vane outlet D_{gvo}.

### DETAILED DESCRIPTION

It is to be noted that the embodiments and features therein of this application may be combined with each other without conflict. This application is described in detail below with reference to the accompanying drawings and in combination with embodiments.

It is to be noted that the steps shown in the flowchart of the accompanying drawings can be executed in a computer system, such as a set of computer-executable instructions. Additionally, although a logical order is illustrated in the flowchart, the steps shown or described may be executed in a different order in some cases.

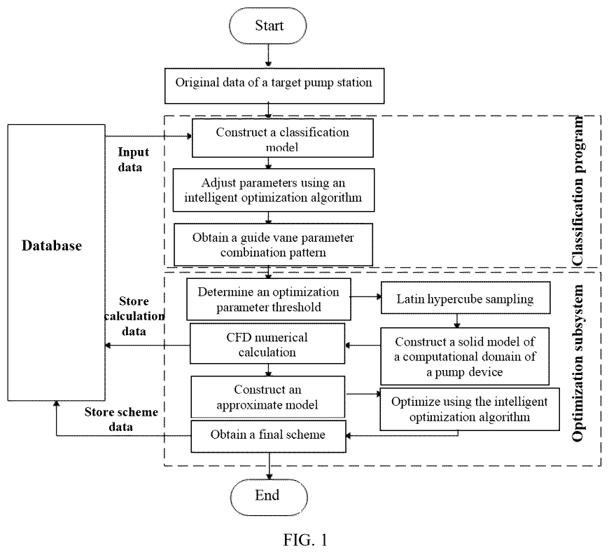

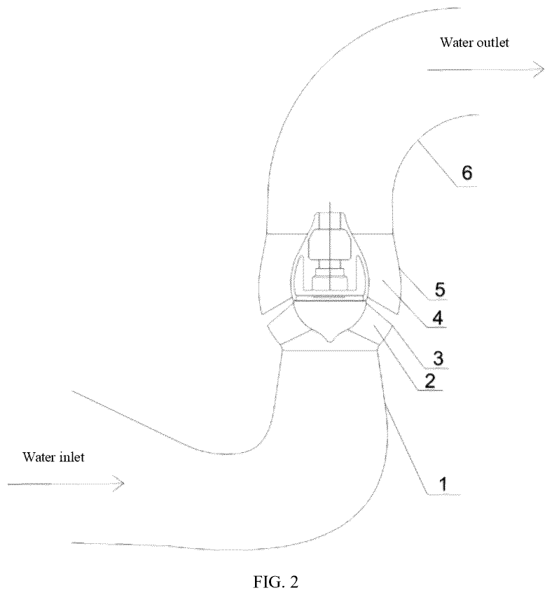

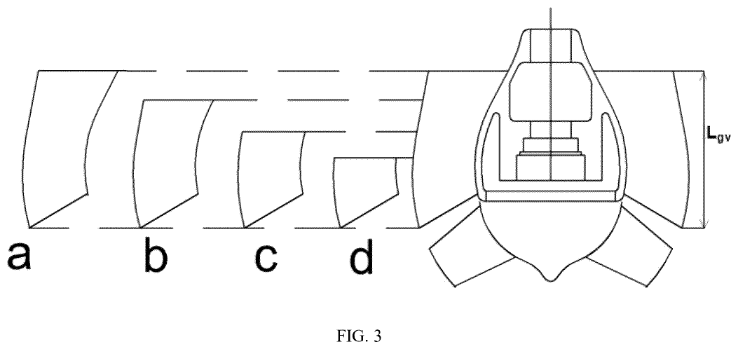

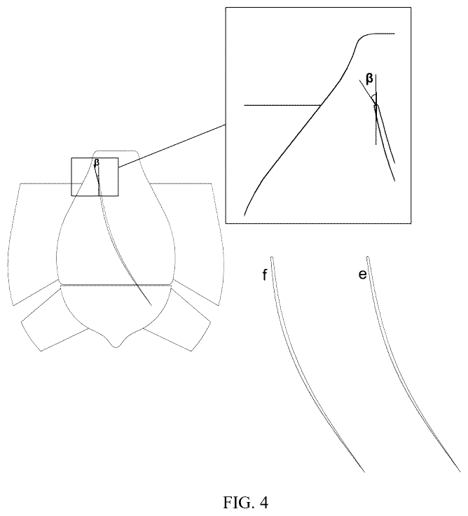

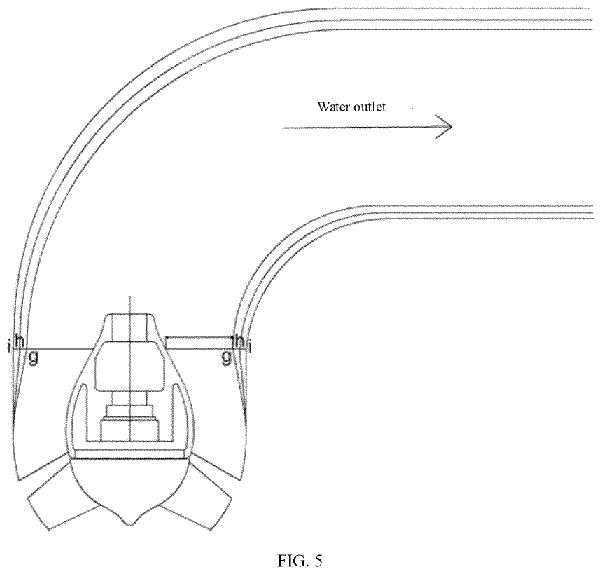

As shown in FIG. 1, an embodiment provides a method for matching a guide vane and an outlet passage of a low-lift pump station, including the following steps. Step 1, original pump station data including a design flow, a design lift, a three dimensional structure of a running wheel, guide vane parameters, and a three dimensional structure of a passage are collected. FIG. 2 shows a schematic structural diagram of a pump device used in an embodiment of the disclosure, where 1, 2, 4, and 6 are an inlet passage, a vane wheel, a guide vane and an outlet passage, respectively, which are jointly spliced into the pump device, and used for illustrating a pump structure and a passage type employed in the embodiment of the disclosure, indicating partial data needed in classification; and 3 and 5 are blades welded to the vane wheel and to the guide vane, respectively. In FIG. 3, (a), (b), (c), and (d) are different parameter schemes for the axial length of the guide vane blade L_{gv}, where (d) is an initial axial length of the guide vane blade of the original pump station in an embodiment of the disclosure. In FIG. 4, (e) and (f) are different parameter schemes for the placement angle of the guide vane outlet β, where (e) is an initial placement angle of the guide vane outlet of the original pump station in an embodiment of the disclosure. In FIG. 5, (g), (h), and (i) are different parameter schemes for the diameter of the guide vane outlet D_{gvo}, where (g) is an initial diameter of the guide vane outlet of the original pump station in an embodiment of the disclosure.

Step 2, according to data in a database, a three-factor (L_{gv}, β, D_{gvo}) combination adjustment pattern is selected through a classification program on the basis of the data of the original pump station. The axial length of the guide vane blade, the placement angle of the guide vane outlet and the diameter of the guide vane outlet are sampled. A solid model of a computational domain of a pump device is established and computational fluid dynamics (CFD) simulation calculations are performed. A nonlinear correlation of threshold parameters in the calculation results is fitted. A fitted nonlinear correlation is optimized using a particle swarm optimization algorithm, to obtain a parameter combination scheme composed of (a), (f), and (i).

The final selected design scheme is composed of the axial length of the guide vane blade (a), the placement angle of the guide vane outlet (f) and the diameter of the guide vane outlet (i).

Specifically,
(1) pump station data including a design flow, a design lift, a three-dimensional structure of a running wheel, guide vane parameters, and a three-dimensional structure of a passage, pump station operation calculation data including a pump efficiency, a hydraulic loss, and a residual circulation distribution at the guide vane outlet, as well as record data of matching schemes are collected.
(2) Since the axial length of the guide vane blade L_{gv}, the placement angle of the guide vane outlet β and the diameter of the guide vane outlet D_{gvo} have self-interference effect on the pump device, the classification program is needed to select a most suitable parameter combination pattern, arbitrarily combining the axial length of the guide vane blade L_{gv}, the placement angle of the guide vane outlet β, and the diameter of the guide vane outlet D_{gvo}, such as: single combination, two-factor combination and three-factor combination, and the most suitable combination pattern is obtained according to the classification algorithm built in the classification program. Therefore, a classification model needs to be established according to the data stored in the database, and the classification is performed according to the similarity between the original data of a target pump station and a residual velocity circulation at the guide vane outlet in the model as well as the built-in algorithm, to obtain a more suitable guide vane parameter combination pattern under this original data. This guide vane parameter combination pattern is used for determining a parameter combination pattern for the axial length of the guide vane blade, the placement angle of the guide vane outlet and the diameter of the guide vane outlet, reducing the computational load in an optimization subsystem.
(3) On the basis of the data stored in the database, a threshold range of parameters including the axial length of the guide vane blade, the placement angle of the guide vane outlet and the diameter of the guide vane outlet is adjusted within a limited optimization parameter threshold range according to the original data of the pump device and the guide vane parameter combination pattern, and optimization variables are sampled.
(4) According to the obtained sampling points, the solid model of the computational domain of the pump device is generated for CFD simulation calculations, and calculation results are transmitted into the database. At the same time, an approximate model is established according to the calculation results, and the nonlinear correlation between the calculation results and the optimization variables is fitted.
(5) Using an intelligent optimization algorithm, the fitted nonlinear correlation is optimized to obtain an optimal scheme under this combination pattern, and a final scheme is obtained by comparing. The optimal scheme obtained by the optimization subsystem is determined to be the final scheme if only one combination pattern is obtained by the classification program.

In the above steps, the solid model of the computational domain of the pump device is constructed according to the original pump station parameters. According to the difference between the original pump station data and the different combination patterns, the set threshold parameters are different. At the same time, the set threshold is adjusted within a limited proper parameter threshold range, to ensure the feasibility of the final scheme obtained.

In the above steps, by means of BladeGen or CFturbo and other rotary machinery design software, the geometric dimension of the guide vane is automatically modified, achieving the function of updating the solid model of the computational domain of the pump device. Meanwhile, the diameter of the guide vane outlet D_{gvo} is the same as that of the outlet passage inlet, the diameter of the guide vane outlet D_{gvo} is adjusted, and the diameter of the outlet passage inlet is synchronously updated, so that the geometric parameters of both the guide vane and the outlet passage are changed. The outlet passage requires to be remodeled using three-dimensional design software such as Creo and Siemens NX, and the solid model of the computational domain of the pump device is synchronously updated. CFD simulation calculations are conducted using ANSYS software, and the required data are exported from the CFD results.

In the steps described above, in the optimization system, intelligent optimization algorithms such as ant colony algorithm, anneal arithmetic, and particle swarm optimization algorithm can be used. The uses of the intelligent optimization algorithm are classified into two categories:

First, they are used in the process of classification of data within database by the classification program, and for parameter tuning in constructing models such as decision-making tree, support vector machine (SVM), and random forest.

Second, they are employed to optimize the nonlinear correlation fitted by execution modules, to obtain the optimal scheme among different combination patterns.

A method for matching a guide vane and an outlet passage of a low-lift pump station is disclosed in the disclosure, and the matching method between guide vanes and outlet passages is integrated. For various pump types and various outlet passage forms in the low-lift pump station, a suitable guide vane parameter combination pattern can be determined by means of the database and the classification program according to their type or similarity in the axial velocity distribution pattern at the guide vane outlet, thereby reducing the computational load in the matching process and enhancing accuracy. Optimization parameters are selected according to the determined guide vane parameter combination pattern, and the optimization parameter threshold is determined on the basis of the database. Fast optimization is performed with the aid of intelligent optimization algorithms, eliminating the influence of manual experience in the matching design process, and quickly and accurately obtaining the design scheme for the guide vane and the outlet passage. This not only shortens the training period for designers, but also maximizes the improvement of water flow patterns in guide vanes and outlet passages, thereby reducing the overall hydraulic losses of the pump device, enhancing the overall efficiency of energy recovery in guide vanes and outlet passages, and consequently boosting the efficiency of the pump device while broadening a high-efficiency operation range of the pump device.

The above mentioned is only the better embodiment of the disclosure, not the limitation to the protection scope of the disclosure. Any modifications or replacements that can easily be thought of by any skilled familiar with the technical field of the disclosure within the technical scope disclosed by the disclosure shall be covered by the protection scope of the disclosure. Therefore, the protection scope of this application is to be defined by the attached claims.

1. A method for matching a guide vane and an outlet passage of a low-lift pump station, comprising:
collecting original data of a target pump station, and selecting, according to the original data, a combination pattern for combined adjustment of an axial length of a guide vane blade, a placement angle of a guide vane outlet and a diameter of the guide vane outlet by classification;
a classification method for selecting the combination pattern for combined adjustment of the axial length of the guide vane blade, the placement angle of the guide vane outlet and the diameter of the guide vane outlet comprising:
constructing a classification model using a classification algorithm according to data stored in a database, and determining the combination pattern and a threshold range for the axial length of the guide vane blade, the placement angle of the guide vane outlet and the diameter of the guide vane outlet according to a pump type, a passage form and the similarity between a distribution pattern of residual velocity circulation at the guide vane outlet and the data stored in the database;
optimizing a selected combination pattern for combined adjustment of the axial length of the guide vane blade, the placement angle of the guide vane outlet and the diameter of the guide vane outlet to obtain an optimal parameter combination scheme, specifically comprising: sampling the axial length of the guide vane blade, the placement angle of the guide vane outlet and the diameter of the guide vane outlet, establishing a solid model of a computational domain of a pump device and performing simulation calculations to obtain calculation results; fitting a nonlinear correlation of threshold parameters in the calculation results, and optimizing a fitted nonlinear correlation using an intelligent optimization algorithm to obtain the optimal parameter combination scheme for the axial length of the guide vane blade, the placement angle of the guide vane outlet and the diameter of the guide vane outlet; and
performing, on the basis of the data stored in the database, adjustment within a limited optimization parameter threshold range according to the threshold range and the combination pattern for the axial length of the guide vane blade, the placement angle of the guide vane outlet and the diameter of the guide vane outlet, and sampling optimization variables; generating the solid model of the computational domain of the pump device according to obtained sampling points, performing the simulation calculations, transmitting the calculation results into the database, establishing an approximate model on the basis of the calculation results, and fitting the nonlinear correlation between the calculation results and the optimization variables; optimizing the fitted nonlinear correlation using the intelligent optimization algorithm to obtain an optimal scheme under the combination pattern, and determining a final scheme by comparing; and determining the optimal scheme obtained by an optimization subsystem to be the final scheme if only one combination pattern is obtained by a classification program.

2. The method for matching a guide vane and an outlet passage of a low-lift pump station according to claim 1, wherein the original data of the target pump station comprise: a design flow, a design lift, a three dimensional structure of a running wheel, guide vane parameters, and a three dimensional structure of a passage of the target pump station.

3. The method for matching a guide vane and an outlet passage of a low-lift pump station according to claim 1, wherein selecting the combination pattern for combined adjustment of the axial length of the guide vane blade, the placement angle of the guide vane outlet and the diameter of the guide vane outlet comprises:
the combination pattern for the axial length of the guide vane blade, the placement angle of the guide vane outlet and the diameter of the guide vane outlet comprising: a single combination pattern, a two-factor combination pattern or a three-factor combination pattern.

4. The method for matching a guide vane and an outlet passage of a low-lift pump station according to claim 1, wherein the data stored in the database comprise:
pump station data comprising the design flow, the design lift, the three dimensional structure of the running wheel, the guide vane parameters, and the three dimensional structure of the passage;
pump station operation calculation data comprising a pump efficiency, a hydraulic loss, and a residual circulation distribution at the guide vane outlet; and
matching scheme data of the guide vane and the outlet passage of the pump station.

5. The method for matching a guide vane and an outlet passage of a low-lift pump station according to claim 1, wherein the final scheme comprises the diameter of the guide vane outlet D_{gvo} being equal to a diameter of an outlet passage inlet, an adjustment to the diameter of the guide vane outlet D_{gvo}, and synchronous updates to the diameter of the outlet passage inlet.
